(19) United States
(12) Patent Application Publication
(10) Pub. No.: US 2024/0168793 A1
(43) Pub. Date: May 23, 2024

(54) Methods and Systems for Checking Container Applications on a Host System for Manipulation

(71) Applicant: Siemens Aktiengesellschaft, München (DE)

(72) Inventors: Stefan Pyka, Markt Schwaben (DE); Roman Bendt, München (DE); Rainer Falk, Erding (DE); Christian Peter Feist, München (DE); Daniela Friedrich, München (DE); Christian Knierim, München (DE); Ricarda Weber, Unterschleissheim (DE)

(73) Assignee: Siemens Aktiengesellschaft, München (DE)

(21) Appl. No.: 18/553,076

(22) PCT Filed: Mar. 17, 2022
(86) PCT No.: PCT/EP2022/057031

§ 371 Date: Sep. 28, 2023

(30) Foreign Application Priority Data
Mar. 31, 2021 (EP) 21166362.0

(51) Int. Cl. G06F 9/455

(52) U.S. Cl. CPC G06F 9/45558; G06F 2009/45575; G06F 2009/45587

(57) ABSTRACT

Various embodiments of the teachings herein include a method for checking container applications on a host system for manipulation. An example method includes: starting a respective checking process on the host system for each of at least two of the container applications; and assigning the respective checking process using a data-technology linkage. The checking processes subject the current behavior of at least one of the container applications other than the respective assigned container application to a comparison with a reference behavior of the at least one other container application.

### CROSS-REFERENCE TO RELATED APPLICATIONS

This application is a U.S. National Stage Application of International Application No. PCT/EP2022/057031 filed Mar. 17, 2022, which designates the United States of America, and claims priority to EP Application No. 21166362.0 filed Mar. 31, 2021, the contents of which are hereby incorporated by reference in their entirety.

### TECHNICAL FIELD

The present disclosure relates to computing. Various embodiments include systems and/or methods for checking container applications on a host system for manipulation and a system.

### BACKGROUND

Many new industrial and nonindustrial IT systems are presently developed in such a way that they can be flexibly adapted to novel requirements. One routine approach for this purpose is to provide a container technology in the IT system and the option of downloading new or modified software solutions with the aid of the container technology as container applications in a rapid and flexible manner into the IT systems.

Such container applications can be executed in this case on previously known or unknown target systems, which are also designated as host systems. Furthermore, the execution of container applications of different providers on the same system is possible. This flexibility due to easily downloadable container applications is accompanied by the threat that manipulated or malicious container applications can also be introduced into the system and compromise it.

For protection from manipulation, container applications are often isolated by means of security mechanisms available on the host, in particular by means of virtualization mechanisms such as Linux Namespaces, chroot, or Hypervisor or by means of access control mechanisms such as a user rights management, SELinux, SMACK, or AppArmor. On the other hand, it is important to check the security status, for example, the integrity of the software or configuration components used and the behavior of the downloaded container applications during the run time in order to establish manipulations or noticeable behavior of the container applications early and therefore be able to continuously ensure the integrity of the host system. However, this checking has to function dependably itself in order to be able to reliably identify an integrity infringement. Known checking solutions form a central instance, however, which attackers can deactivate or manipulate in another manner with corresponding effort.

There is therefore a need for an improved solution for checking container applications for manipulation. In particular, the reliability and security from manipulation of the checking are to be improved. Solutions for checking container applications are known which use Enforcer or MicroEnforcer, for example from AquaSec (https://www.aquasec.com/news/aqua-3-O-delivers-runtime-security-for-zero-infrastructure-container-as-a-service-environments/). Further solutions for checking container applications are provided, for example, by providers such as NeuVector (https://neuvector.com) or Sysdig (https://sysdig.com/). In this case, typically or more containers are checked for harmful behavior (unauthorized network accesses or using specific commands/system calls). Moreover, general checking systems for integrity checking are known, such as Wazuh (www.wazuh.com), OSSEC (www.ossec.net), Nagios (www.nagios.org) Tripwire (www.tripwire.org), and Falco (www.falco.org). These solutions assist, inter alia, identifying non-legitimate processes, impermissible modification of files, write accesses, or establishment or use of network connections by processes. If unauthorized events or deviations from a reference are detected, an alarm is generated, for example in the form of a log message.

### SUMMARY

Against this background, the teachings of the present disclosure provide methods and/or systems for checking container applications on a host system for manipulation. For example, some embodiments include a method for checking (UEB) container applications (CONT1, CONT2, CONT3) on a host system (H) for manipulation, in which a checking process (UEKO) is started on the host system (H) for each of at least two of the container applications (CONT1, CONT2, CONT3) and is assigned, preferably by means of a data-technology linkage, wherein the checking processes (UEKO) subject the current behavior of at least one of the container applications (CONT1, CONT2, CONT3) other than the respective assigned container application (CONT1, CONT2, CONT3) to a comparison with a reference behavior (UKONF) of the at least one other container application (CONT1, CONT2, CONT3).

In some embodiments, occurring manipulation of the at least one container application (CONT1, CONT2, CONT3) subjected to the comparison is concluded depending on the comparison.

In some embodiments, the reference behavior (UKONF) of the container application (CONT1, CONT2, CONT3) is communicated with the checking processes (UEKO) upon the start and/or stop and/or upon a change of the at least one other container application (CONT1, CONT2, CONT3).

In some embodiments, the checking process (UEKO) is assigned to the respective container application (CONT1, CONT2, CONT3) in that the checking process (UEKO) is started as part of the respective container application (CONT1, CONT2, CONT3).

In some embodiments, the current behavior of the at least one other container application (CONT1, CONT2, CONT3) is subjected to a comparison with the reference behavior (UKONF) with respect to a response behavior to a question and/or with respect to an operating behavior and/or with respect to a behavior upon a manipulation attempt and/or upon an occurring manipulation.

In some embodiments, a reference behavior component (KOKO) communicates the reference behavior (UKONF) to the monitoring processes (UEKO).

In some embodiments, the reference behavior component (KOKO) is cryptographically protected.

In some embodiments, the reference behavior component (KOKO) is implemented by means of a distributed database.

As another example, some embodiments include a system, including container images for container applications (CONT1, CONT2, CONT3) and a host system (H), designed to execute one or more of the methods described herein.

In some embodiments, the system is a manufacturing (A) and/or processing system.

### BRIEF DESCRIPTION OF THE DRAWING

The invention will be explained in more detail hereinafter on the basis of exemplary embodiments illustrated in the drawing.

The FIGURE shows a system incorporating teachings of the present disclosure including a host system for executing a method for checking container applications on a host system schematically in a schematic diagram.

### DETAILED DESCRIPTION

In an example method for checking container applications on a host system, a checking process on the host system is started for each of at least two of the container applications and assigned, preferably by means of a data-technology linkage, wherein the checking processes subject the current behavior of at least one of the container applications other than the respective assigned container application to a comparison using a reference behavior of the at least one other container application. The method described is used to check container applications for manipulation and/or to check container applications for manipulation attempts.

The assignment of the checking process to a container application by means of a data-technology linkage can take place in particular in that the checking process receives access to a resource of the container application, which may be managed by the host system. The checking process can then in particular use a file handle and/or a pointer and/or a link and/or a key or magic number or a so-called capability in order to access the resource of the assigned container application managed on a host system. The checking process has a link or a reference to the resource of the assigned container application in this case.

In some embodiments, the resource is an interprocess communication resource and/or a shared memory area and/or a pipe and/or a message queue and/or a socket and/or a namespace, and/or a control group. The checking process may at least have reading access in this case to the resource of the assigned container application managed by the operating system. By means of the resource managed by an operating system, the checking program can in particular ascertain runtime integrity monitoring information of the assigned container application dependent on the current behavior of the container application and check it using reference information of the assigned container application.

Checking of the at least one container application other than the respective assigned container application can also take place indirectly by way of the checking process assigned to the container application. Its current behavior can be checked here in that its interaction with the container application assigned to the checking process is ascertained using the at least one other container application by the checking process and is compared for correspondence with the reference behavior of the at least one other container application. Indirect checking of the other container application thus takes place here. In particular, it can be ascertained on the basis of the interaction whether the other container checking is checked by a checking process assigned thereto. Furthermore, the other container application or the other checking process of the container application assigned thereto can explicitly provide checking information, which can be checked by the checking process assigned to this container application.

A container application assigned to a checking process is to be understood as that container application which is assigned to the checking process in each case. Different container applications are expediently each assigned to different, i.e., non-identical checking processes.

Container applications are thus not checked by means of a central component, rather decentralized checking processes are started and assigned to the respective container applications. The checking processes are designed and configured to acquire the current behavior of at least one other container application and to subject it to a comparison with a reference behavior of the at least one other container application. In this way, at least two container applications are checked by at least two checking processes. It is therefore not sufficient for an attacker to manipulate a single central checking process in order to be able to manipulate container applications, rather at least two checking processes have to be compromised in order to be able to manipulate the container applications. In some embodiments, each of the container applications is respectively assigned a different, i.e., a separate checking process. I.e., checking processes are each only assigned to a single one of the container applications, and not multiple container applications.

In some embodiments, not only two of the container applications are each assigned a checking process, but rather three or four or more container applications are each assigned a dedicated checking process. The more checking processes are provided, the more difficult it becomes for an attacker to manipulate all checking processes individually. In some embodiments, all checking processes are configured to subject the current behavior of at least two, e.g. three or more or all, of the container applications other than the respective assigned container application to a comparison with a reference behavior of the at least one other container application. Therefore, by means of the checking process, not only is a single container application checked, but rather multiple or all of the container applications running on the host system can be checked. This significantly increases the security of the host system having container applications running thereon.

Depending on the comparison to an occurring or non-occurring manipulation, the at least one container application subjected to the comparison may be closed. In some embodiments, upon an occurring or non-occurring manipulation, each one or each of the multiple or all of the at least one container application subjected to the comparison is closed, i.e., the closing upon an occurring or non-occurring manipulation preferably occurs in each case for one or each of the at least one container application. In this manner, individual manipulated container applications can be identified. If the comparison results in a deviation between the behavior of the container application and the reference behavior, an occurring manipulation of the container application is thus concluded.

An alarm message or an alarm signal can thereupon be provided and/or a network communication of the affected container application or the host can be limited and/or the access to an input/output interface of the host by the affected container application can be blocked or it can be blocked in general, and/or the affected container application can be stopped or ended or restarted. Furthermore, it is possible that a restart of the program code, i.e., the container image, of the affected container application on the host is blocked.

In some embodiments, when an occurring manipulation of the at least one container application is concluded, an alarm message or an alarm signal is provided and/or a network communication of the affected at least one container application or the host is limited and/or the access to an input/output interface of the host by the affected at least one container application is blocked or is blocked in general, and/or the affected at least one container application is stopped or ended or restarted and/or a restart of a program code, i.e., a container image, of the affected at least one container application on the host is blocked.

The reference behavior of the container application may be communicated to the checking processes upon the start and/or stop and/or upon a change of the at least one other container application, i.e., information about the reference behavior is communicated. In this way, it is possible to react flexibly to restarted and/or changed and/or stopped container applications. In some embodiments, the reference behavior of a stopped container application is not considered further. The reference behavior may be supplemented in the case of restarted container applications and the reference behavior is adapted in the case of changed container applications.

In some embodiments, the checking process is assigned to the respective container application in that the checking process is started as part of the respective container application. The checking processes may be assigned to the at least two container applications such that the checking processes are each part of one of the at least two container applications. In this way, the checking process is automatically initialized in each case with the starting of the container application. By means of the joint starting of container application and checking process, the checking process is automatically assigned to the respective container application in that the host system necessarily registers and manages the checking process as part of the container application and continuously internally assigns the checking process to the container application.

In some embodiments, the checking process can be an operating system process. In this refinement, the method for checking container applications on a host system, in which in at least two of the container applications, a checking process is started in each case on the host system as part of the respective container application, wherein the checking processes subject the current behavior of at least one of the container applications other than the container application which they are respectively part of to a comparison with a reference behavior of the at least one other container application.

In some embodiments, the current behavior of the at least one other container application with the reference behavior is subjected to a comparison with respect to a response behavior to a query, i.e., a query message, and/or with respect to an operating behavior and/or with respect to a behavior in the event of a manipulation attempt and/or in the event of an occurring manipulation.

In some embodiments, a reference behavior component communicates the reference behavior to the checking processes. The reference behavior component can be provided as a central component. The reference behavior component can be administered easily and reliably. In some embodiments, the reference behavior component can be assigned, expediently redundantly, to each of at least two or more container applications or can be part of the two or more container applications.

In some embodiments, the reference behavior component is cryptographically protected. The reference behavior component is in turn particularly protected against manipulation. Reference information used by the reference behavior component can be cryptographically protected here, encrypted and/or protected by a cryptographic checksum. In some embodiments, the program code of the reference behavior component can be encrypted or protected by a cryptographic checksum, or it can be provided in obfuscated form. Furthermore, the reference behavior component can comprise a self-integrity checking component, which checks the integrity of the reference behavior component at the runtime.

In some embodiments, the reference behavior component is expediently implemented by means of a distributed database. The reference behavior component is not provided as a central component, which is therefore potentially more easily manipulable, but rather the reference behavior component is significantly harder to manipulate as a distributed database. This is because a manipulation of at least a predominant part of the distributed database or the complete distributed database would be a condition for a manipulation of the reference behavior component. The distributed database can be implemented as a distributed ledger database or as a block chain database, in which a data set is confirmed in a cryptographically protected manner by a block of a block chain. In addition to the reference behavior component, the checking information of a container in a distributed database can also be provided to one or more checking processes for inspection. In some embodiments, the checking process can be implemented by a smart contract program code of the distributed database.

As another example, some embodiments include a system with container images for container applications and a host system, and is designed for executing one or more of the methods as described herein.

In some embodiments, the system is a manufacturing and/or processing system, e.g. a machine tool, a driverless transport system, or a robot.

On the example host system H of the system A incorporating teachings of the present disclosure shown in the FIGURE, a container runtime environment is started. Within the container runtime environment, container applications CONT1, CONT2, CONT3 are started by means of container images. In contrast to what is known in the prior art, in the method executed on the host system H, the container applications CONT1, CONT2, CONT3 are not checked for manipulation and for manipulation attempts by means of a central checking component.

Instead, decentralized checking of the container applications CONT1, CONT2, CONT3 is carried out by means of the method according to the invention. In the illustrated exemplary embodiment, the checking of the container applications CONT1, CONT2, CONT3 is alternately carried out by the container applications CONT1, CONT2, CONT3 themselves. On the host system according to the invention, initially all typical hardening measures known per se are carried out for the container runtime environment, here a mandatory access control, a control of the name spaces, and a restriction of the authorizations of the container applications CONT1, CONT2, CONT3 and/or restriction of the communication, for example by means of Calico or other SDN (software defined networking) solutions known per se. By means of the hardening measures, container applications CONT1, CONT2, CONT3 on the host system H cannot see sensitive data of other container applications CONT1, CONT2, CONT3.

A configuration component KOKO is implemented on the host system H, which provides checking configuration information UKONF to a currently active runtime configuration, i.e., to a configuration of currently executed container applications. This configuration component KOKO can be, for example, the container runtime environment itself or a configuration component KOKO independent thereof and forms a reference behavior component in the meaning of the present disclosure.

The checking configuration information UKONF contains a set of reference values for the checking. These reference values include in the illustrated exemplary embodiment specifications about the type and the number of the running container applications and checksums of the running container applications and specifications about rights of the container applications and specifications about permissible network activities of the container applications as well as specifications about maximum consumption of resources such as CPU time or RAM by the running container applications. In further exemplary embodiments (not shown separately), further items of checking configuration information can be added or can be absent.

The checking configuration information UKONF associated with the respective container application can either be defined or computed by the configuration component KOKO itself or it can already be contained in the container image. For example, the container image can contain a specification of how many network resources or CPU resources the container applications CONT1, CONT2, CONT3 each require. These specifications in the container image are checked by the configuration component KOKO and either accepted and incorporated in the checking configuration information UKONF or rejected. In the latter case, a start of the container application is rejected.

The configuration component KOKO is moreover responsible for changes of the checking configuration information UKONF in cases in which container applications are started or changed or stopped. For example, a container application can be started or updated: The checking configuration information UKONF is updated in such cases. For example, reference values for network activities are defined or changed or checksums about contents of the container applications are ascertained or recalculated. The configuration component KOKO thereupon either itself updates the checking configuration information UKONF or initiates the adaptation of the checking configuration information to the newly ascertained or changed reference values. If container applications are stopped, elements of the checking configuration information UKONF associated with the corresponding container application CONT1, CONT2, CONT3 are thus deleted. The checking configuration information UKONF is expediently deleted from the configuration component KOKO and from the container applications CONT1, CONT2, CONT3, to which it has been transmitted.

In the illustrated exemplary embodiment, the configuration component KOKO is formed as a result of an implementation as a trustworthy execution environment, so that manipulations of the configuration component KOKO by an attacker having corresponding rights are made more difficult and the configuration component KOKO can in principle be viewed as trustworthy. The checking configuration information UKONF is provided to the container applications CONT1, CONT2, CONT3 as reference information, so that these each implement a checking functionality having a checking component UEKO described hereinafter.

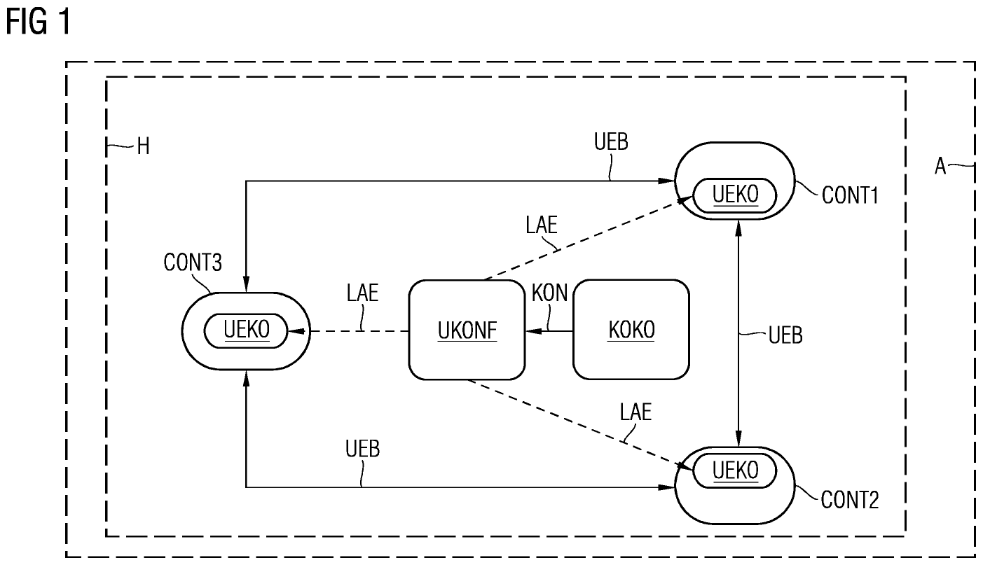

The checking component UEKO is implemented in the illustrated exemplary embodiment not as a central component, rather in each case is implemented as a decentralized checking component UEKO of the container applications CONT1, CONT2, CONT3 themselves, which each check the remaining container applications CONT1, CONT2, CONT3. The checking components UEKO of the container applications CONT1, CONT2, CONT3 are designed to execute checking actions UEB in the form of acquiring activities of other container applications CONT1, CONT2, CONT3 and comparing the acquired activities to reference values contained the in checking configuration information UKONF. Moreover, the checking actions UEB comprise a liveliness check of other container applications (not shown separately in FIG. 1) and port scans on the host system H and a request for activities of container applications CONT1, CONT2, CONT3 acquired by other container applications CONT1, CONT2, CONT3 and an of acquired of container attestation activities applications CONT1, CONT2, CONT3 to other checking components UEKO.

If a checking component UEKO establishes deviations of the acquired activities of a container application CONT1 in comparison to the provided reference values, it initiates countermeasures. These include, for example, informing the other checking components UEKO about the measured deviation of the checked container application CONT1 and informing a component outside the container applications CONT1, CONT2, CONT3, which executes more extensive measures, such as stopping the checked container application.

In the illustrated exemplary embodiment, the checking configuration information UKONF is managed by the configuration component KOKO. Each container application CONT1, CONT2, CONT3 includes a separate checking component UEKO here, which is responsible for checking the other container application CONT1, CONT2, CONT3 on the host system H, and which loads the checking configuration information UKONF managed by the configuration component KOKO by means of loading processes LAE. In the illustrated exemplary embodiment, the checking UEB of the container applications CONT1, CONT2, CONT3 is carried out by many container applications CONT1, CONT2, CONT3 simultaneously and no longer by a central instance. However, the described method has the disadvantage that the checking configuration information UKONF having the central configuration component KOKO is itself again a central attack point for a possible manipulation.

In some embodiments, the checking configuration information UKONF is therefore no longer managed by means of a central configuration component KOKO, but rather the managing is carried out by means of the container applications themselves. For this purpose, the current checking configuration information UKONF is incorporated in each case as reference information upon starting of a container application CONT1, CONT2, CONT3 into the respective container image or into the file system of the loaded container instance.

The configuration component KOKO is only still designed in this exemplary embodiment to transmit to all containers changes of the reference values to be carried out upon starting, changing, and stopping a container application in the checking configuration information UKONF. The configuration component KOKO at most still checks the consistency of the checking configuration information UKONF with the current actually started container applications CONT1, CONT2, CONT3 here. This is carried out, for example, in that the current checking process is stopped until the changes have been carried out in all items of checking configuration information UKONF of the running container applications CONT1, CONT2, CONT3. Alternatively, a time window can be defined in which checking components UEKO accepts deviations of reference values in the checking configuration information UKONF or elements of the checking configuration information UKONF which are absent or have become obsolete as a result of stopped container applications CONT1, CONT2, CONT3.

In the illustrated exemplary embodiment, one checking component UEKO is introduced into each of the container applications CONT1, CONT2, CONT3. In some embodiments, it can be checked upon the start of a new container application whether a suitable checking component UEKO is present in the container image of the new container application. Otherwise, the execution of the new container application is prevented. In this, it can be ensured that each of the container applications contains a checking component UEKO.

In some embodiments, during the construction of the container image to be executed on a host system or multiple different host systems, a checking component UEKO can be integrated in each case into the container image.

In some embodiments, an independent checking process can be started on the host system H assigned to each container application CONT1, CONT2, CONT3, which compares its checking configuration information UKONF with the checking processes of other container applications CONT1, CONT2, CONT3. In these exemplary embodiments, the checking configuration information UKONF and the checking components UEKO are thus not located in the container applications CONT1, CONT2, CONT3 themselves, but rather in each case in checking processes on the host system H corresponding to the container applications CONT1, CONT2, CONT3.

The checking components UEKO of the illustrated exemplary embodiment, which are component parts of the respective container applications CONT1, CONT2, CONT3, can check not only further container applications CONT1, CONT2, CONT3 of the same producer, but also container applications of other producers.

In some embodiments, no items of information in the checking configuration information UKONF contain sensitive data about the container application itself. This can be implemented, for example, by a policy defined in the container image, which is provided upon starting of the respective container application of the external producer of the configuration component KOKO and in which it is described which reference values are permitted for the checking UEB. The configuration component KOKO then decides whether it wishes to start this container application or whether a start is forbidden, for example, because the policy of the container application CONT1, CONT2, CONT3 is too restrictive.

The checking process itself, which is carried out by the checking components UEKO of the individual container applications CONT1, CONT2, CONT3, can either be carried out independently by each container application CONT1, CONT2, CONT3 itself or the checking processes can apply a peer-to-peer mechanism (P2P mechanism), in which the container applications exchange the acquired activities in order to then compare them to the reference values in the checking configuration information UKONF.

In addition to the comparison of reference values in the checking configuration information UKONF, the checking components UEKO of the container applications CONT1, CONT2, CONT3 can moreover also acquire noticeable activities of other container applications CONT1, CONT2, CONT3 in a more active manner:

The activities of container applications CONT1, CONT2, CONT3 can thus be checked and classified as potentially hazardous if these container applications do not supply the expected response to a normal request. The checking by the checking components therefore does not extend solely to passive checking, but can also comprise the active sending of requests to the checked container application CONT1, CONT2, CONT3.

The checking components UEKO can also perform checking UEB actively by means of dynamic test queries, i.e., query messages to other container applications, for example, queries for items of information about internal hash values or contents of specific files. The answers received are acquired, for example, by the checking components UEKO and compared to values calculated by the checking components UEKO themselves.

The checking components UEKO can moreover place requests, which do not correspond to the normal behavior, to other container applications in the illustrated exemplary embodiment. In case of success, the checking component UEKO then gives an alarm.

What is claimed is:

1. A method for checking container applications on a host system for manipulation, the method comprising:
starting a respective checking process on the host system for each of at least two of the container applications; and
assigning the respective checking process using a data-technology linkage;
wherein the checking processes subject the current behavior of at least one of the container applications other than the respective assigned container application to a comparison with a reference behavior of the at least one other container application.

2. The method as claimed in claim 1, further comprising ending manipulation of the at least one container application subjected to the comparison is concluded depending on the comparison.

3. The method as claimed in claim 1, in which further comprising communicating the reference behavior of the container application with the checking processes upon the start and/or stop and/or upon a change of the at least one other container application.

4. The method as claimed in claim 1, wherein the checking process is assigned to the respective container application by starting the checking process as part of the respective container application.

5. The method as claimed in claim 1, further comprising subjecting the current behavior of the at least one other container application is subjected to a comparison with the reference behavior with respect to a response behavior to a question and/or with respect to an operating behavior and/or with respect to a behavior upon a manipulation attempt and/or upon an occurring manipulation.

6. The method as claimed in claim 1, further comprising communicating with a reference behavior component the reference behavior to the monitoring processes.

7. The method as claimed in claim 1, wherein the reference behavior component is cryptographically protected.

8. The method as claimed in claim 1, in which wherein the reference behavior component is implemented by means of a distributed database.

9. A system, including;
container images for container applications; and
a host system, designed to:
starting a respective checking process on the host system for each of at least two of the container applications; and
assigning the respective checking process using a data-technology linkage;
wherein the checking processes subject the current behavior of at least one of the container applications other than the respective assigned container application to a comparison with a reference behavior of the at least one other container application.

10. The system as claimed in claim 9, wherein the system comprises a manufacturing and/or processing system.
